(19) United States
(12) Patent Application Publication
(10) Pub. No.: US 2008/0217341 A1
(43) Pub. Date: Sep. 11, 2008

(54) HYGIENIC BAKING PAN AND METHODS FOR PRODUCING AND USING SAME

(75) Inventors: Dennis Scott Wolever, Marysville, OH (US); Richard Patrick Egnor, Hunsville, OH (US); John David Wood, Delaware, OH (US); Michael Edwin Mullaney, Raymond, OH (US); Gregory Howard Westfall, Marysville, OH (US)

Correspondence Address: BELL, BOYD & LLOYD LLP, P.O. Box 1135, CHICAGO, IL, 60690, US

(73) Assignee: NESTEC S.A., Vevey (CH)

(21) Appl. No.: 11/684,299

(22) Filed: Mar. 9, 2007

(51) Int. Cl. A47J 27/022; A47J 27/00; B23P 17/04

(52) U.S. Cl. 220/573.1; 220/573.2; 29/592

(57) ABSTRACT

The present disclosure is directed toward an apparatus for preparing food products. Specifically, a hygienic baking pan comprises a panel having a continuously formed structure comprising at least two sides. The hygienic baking pan may also comprise a frame joined to the panel and/or a plurality of concave molds formed therein. Additionally, the present disclosure includes methods for manufacturing an apparatus for preparing food products. The method includes manufacturing a single continuous sheet of metal material to form a tray having a top surface and two sides, forming the metal material sheet to form a plurality of concave molds therein, and joining a frame to the metal material sheet, wherein a gap is formed between the frame and the metal material sheet.

### BACKGROUND

The present disclosure is generally directed to food technology. More specifically, the present disclosure is directed to hygienic baking pans and methods for producing same.

There are a variety of baking pans currently on the market. However, most of the existing baking pans are unable to provide good release of a food product without having a non-stick agent or coating applied thereto. Similarly, existing baking pans may include cracks or crevices in the surface of the pan that prevent the baking pan from having a surface that meets certain hygienic standards.

Therefore, there is a need to provide improved hygienic baking pans and methods for producing and using same.

### SUMMARY

The present disclosure generally provides baking pans, methods of manufacturing same and method of using such pans. The apparatuses of the present disclosure comprise a panel having a continuously formed structure. The apparatuses may also comprise a frame joined to the panel. The panel may be made from a metal material and may have a plurality of concave molds formed therein. The present disclosure may be used, for example, for improved release of a food product, for producing a food product having an increased depth, and for providing a hygienic surface for baking a food product.

Pursuant to an embodiment of the present disclosure, an apparatus for preparing food products is provided. The apparatus may include a panel having a continuously formed structure comprising at least two sides and having a frame joined to the panel. The frame and the panel further define a gap therebetween. The gap allows for convenient cleaning of the apparatus and prevents build-up of a food product during or after use of the apparatus.

In an embodiment, the frame may comprise at least one stainless steel support bar. However, the frame may also comprise three support bars. The panel may have a top surface and a bottom surface.

In an embodiment, the panel may further comprise two sides and two edges. Each of the two sides may include a double fold. The double fold may comprise a first fold that orients the side of the panel from a substantially horizontal direction to a substantially vertical direction, and a second fold that orients the panel from a substantially vertical direction to a substantially horizontal direction extending inward from the side. Similarly, each of the two edges may include a single fold. The single fold may comprise a first fold that orients the edge of the panel from a substantially horizontal direction to a substantially vertical direction extending downward from top surface of the panel.

In an embodiment, the frame comprises three support bars where one support bar is joined to each of the single folds on the two edges of the panel, and one support bar is joined to the bottom surface of the panel.

In an embodiment, the gap is further defined by a support bar joined to a bottom surface of the panel and the double fold. Further, the gap may extend for a majority of a junction between the frame and the panel.

In an embodiment, the panel is made from a material having non-stick properties relative to the food product being prepared. For example, in an embodiment, the material is stainless steel.

In another embodiment, an apparatus for preparing food products is provided. The apparatus includes a panel having a continuously formed structure comprising at least two sides and defining exposed surfaces. The exposed surfaces are fully accessible and so constructed and arranged as to not define any points of accumulation.

In an embodiment, the panel may further comprise a plurality of concave molds formed therein.

In an embodiment, the panel also comprises a frame joined to the panel defining a gap therebetween and exposed surfaces. The exposed surfaces are fully accessible except at junctions where the frame is joined to the panel and are so constructed and arranged as to not define any points of accumulation.

In yet another embodiment, an apparatus for preparing food products is provided. The apparatus includes a stainless steel panel having a continuously formed structure comprising at least two sides.

In an embodiment, the stainless steel panel may further comprise a plurality of concave molds formed therein.

In an embodiment, the apparatus further comprises a frame joined to the panel defining a gap therebetween. The frame may comprise at least one support bar.

In still yet another embodiment, an apparatus for preparing food products is provided. The apparatus includes a panel comprising a top surface, a bottom surface, a plurality of concave molds and having a frame joined to the panel. The concave molds may extend downward, for example, at least 12 millimeters from the top surface of the panel.

In an embodiment, the concave molds have a substantially semi-cylindrical shape. The molds may also have a substantially smooth surface. The concave molds may have dimensions of from about 80 millimeters to about 96 millimeters by about 18 millimeters to about 22 millimeters by about 10 millimeters to about 14 millimeters. The molds may also be spaced from about one inch to about two inches apart.

In an embodiment, the panel is stainless steel.

In an embodiment, the panel further comprises from about 8 to about 14 columns and from about 4 to about 8 rows of concave molds.

In an embodiment, the frame may comprise at least one support bar.

In another embodiment, methods for manufacturing apparatuses for preparing food products are provided. The methods include manufacturing a single continuous sheet of metal material to form a tray having a top surface and two sides, forming the metal material sheet to form a plurality of concave molds therein, and joining a frame to the metal material sheet, wherein a gap is formed between the frame and the metal material sheet.

In an embodiment, the metal material is stainless steel.

In an embodiment, the metal material sheet may be formed by stamping. Similarly, the metal material sheet may also be formed by hydroforming.

In an embodiment, the method further comprises annealing the metal material sheet.

In an embodiment, the sides of the metal material sheet may be folded with a double fold. Similarly, two edges of the metal material sheet may be folded with a single fold.

In an embodiment, the method further comprises using a brazing paste to join the frame to the metal material sheet. The brazing paste may be a bronze brazing paste.

An advantage of the present disclosure is to provide a hygienic baking pan.

Another advantage of the present disclosure is to provide a hygienic baking pan that provides concave molds.

An additional advantage of the present disclosure is to provide a hygienic baking pan that includes a hygienic surface and frame.

A further advantage of the present disclosure is to provide a hygienic baking pan having increased rigidity.

An advantage of the present disclosure is to provide improved pans for preparing food products.

Another advantage of the present disclosure is to provide improved methods for making pans for preparing food products.

Still yet another advantage of the present disclosure is to provide improved methods for preparing food products.

Additional features and advantages are described herein, and will be apparent from, the following Detailed Description and the figures.

### BRIEF DESCRIPTION OF THE FIGURES

FIG. 1 illustrates a front perspective view of a hygienic baking pan in accordance with an embodiment of the present disclosure.

FIG. 2 illustrates a perspective view of a panel of the hygienic baking pan having shape memory after stamping in accordance with an embodiment of the present disclosure.

FIG. 3 illustrates a front view of a panel of the hygienic baking pan having shape memory after stamping in accordance with an embodiment of the present disclosure.

FIG. 4 illustrates a front perspective view of an annealed panel in accordance with an embodiment of the present disclosure.

FIG. 5 illustrates a front perspective view of the bottom surface of a panel of a hygienic baking pan showing a double fold, a single fold and a support bar in accordance with an embodiment of the present disclosure.

FIG. 6 illustrates a cross-sectional view of a hygienic baking pan in accordance with an embodiment of the present disclosure and taken along line 6-6 of FIG. 1.

FIG. 7 illustrates a cross-sectional view of a hygienic baking pan in accordance with an embodiment of the present disclosure and taken along line 7-7 of FIG. 1.

FIG. 8 illustrates a bottom perspective view of a hygienic baking pan showing double folds, single folds and support bars in accordance with an embodiment of the present disclosure.

FIG. 9 illustrates a bottom perspective view of a hygienic baking pan showing the bottom surface of a panel, a double fold, a support bar, and brazing in accordance with an embodiment of the present disclosure.

### DETAILED DESCRIPTION

The present disclosure is generally directed to food technology. More specifically, the present disclosure is directed to baking pans and methods for producing and using same. For example, the hygienic baking pan of the present disclosure allows for several advantages in preparing a food product including, for example, increased production, improved product size and improved hygienic surfaces. In various embodiments, the present disclosure provides an increased numbers of concave molds per hygienic baking pan, increased depths of the concave molds and improved hygienic surfaces. While the Figures of the present disclosure illustrate embodiments wherein the hygienic baking pan comprises a plurality of concave molds, it is understood that the hygienic baking pan need not comprise concave molds, as will be discussed further herein.

As shown in FIG. 1, an embodiment of a hygienic baking pan of the present disclosure is generally designated by the numeral 10. The hygienic baking pan 10 includes a panel 12 and a frame 22. As shown, the hygienic baking pan 10 assumes a substantially rectangular configuration. However, while the hygienic baking pan 10 is shown in a substantially rectangular configuration, other geometric shapes are possible. For example, the hygienic baking pan 10 may be substantially oval, circular, square, triangular or other various geometric shapes.

In the same way, the dimensions of the hygienic baking pan 10 may also vary. For example, in an embodiment, the hygienic baking pan 10 has dimensions of about 26 inches by about 18 inches. However, the hygienic baking pan 10 may also have larger or smaller dimensions as desired and/or depending on production specifications. For example, the hygienic baking pan 10 may also have dimensions from about 22 inches to about 30 inches by about 16 inches to about 20 inches. The frame 22 in the illustrated embodiment of FIG. 1 comprises two support bars 24, 26 (one support bar is not shown). Of course, however, any number of support bars can be used.

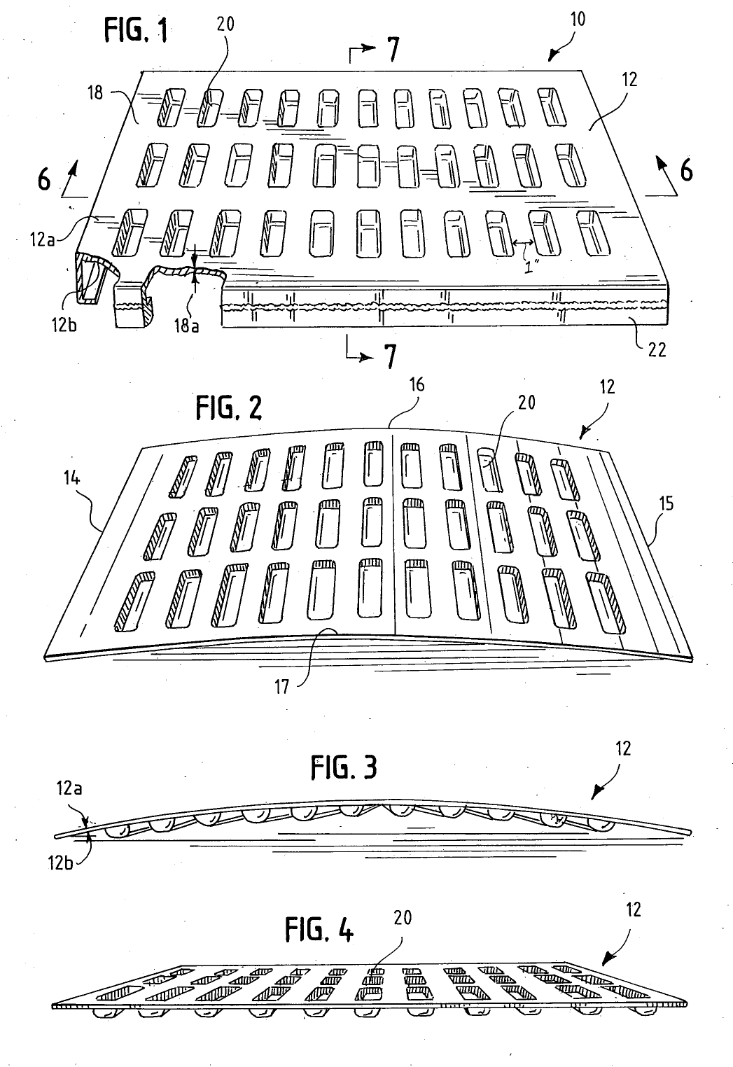

The panel 12 of the hygienic baking pan 10 may have a top surface 12a, a bottom surface 12b, sides 14, 15, and edges 16, 17, as shown in FIG. 2. In an embodiment, the panel 12 has a continuously formed structure comprising at least two sides. In other words, for example, the panel 12 of the present disclosure can comprise one single piece of metal material 18 that may be deformed to impart desired shapes into the panel 12. For example, instead of requiring an independently constructed frame to be applied to all sides 14, 15 and edges 16, 17 of the panel 12, when possible, the sides 14, 15 and edges 16, 17 of the panel 12 may be folded to provide a desired amount of rigidity to the panel 12, as will be further discussed herein below.

The hygienic baking pan 10 may comprise a panel 12 having a substantially flat top surface 12a and a substantially flat bottom surface 12b. In this embodiment, the hygienic baking pan 10 may be used to prepare a food product by, for example, placing an uncooked food product on the top surface 12a of the panel 12 and then placing the hygienic baking pan 10 into an oven to cook the food product. It is to be appreciated, however, that the panel 12 need not be substantially flat and may take on other shapes or forms, as will be discussed herein below.

In an embodiment, the panel 12 may be made of a metal material 18. The metal material 18 may be a sheet metal, the shape of which is capable of being deformed. Forming sheet metal into complex shapes can involve a number of distinct processing steps. For example, the concave molds may be formed by any shaping process known in the art including conventional metal processes such as molding, forging, casting, hydroforming and stamping. Hydroforming, for example, is a specialized type of die forming that uses a high pressure hydraulic fluid to press room temperature working material into a die. Hydroforming allows complex shapes with concavities to be formed, which would otherwise be difficult or impossible with traditional forming methods. In an embodiment, however, the metal material 18 is formed by stamping, as will be discussed herein below.

The metal material 18 may have a thickness 18a in the range of from about 0.7 millimeters to about 0.9 millimeters. Preferably, the metal material 18 has a thickness 18a of about 0.8 millimeters.

Further, the metal material 18 may be any metal material including, but not limited to, tin, aluminum, steel, tempered steel, spring steel, aluminized steel, stainless steel, or the like, or combinations thereof. In an embodiment, the metal material 18 is stainless steel. Although some of the embodiments discussed herein below include a panel 12 made from stainless steel, the skilled artisan will appreciated that the panel 12 need not be made from stainless steel and may be made from other suitable metal materials 18 such as, but not limited to, those discussed herein above. It should also be appreciated, however, that the material used to make the panel 12 should be a material having non-stick properties relative to the food product being prepared. In other words, the food product being prepared should not stick to the panel 12 during release of the food product from the panel 12.

The use of stainless steel as the metal material 18 is advantageous because stainless steel does not require a non-stick agent or coating to be applied to the hygienic baking pan 10 to have good release of the food product after baking and to prevent corrosion of the metal material 18. In contrast, when baking pans are made using, for example, a spring steel or an aluminized steel, the pans may require coating with a non-stick agent or coating, such as TEFLON® (i.e., fluorocarbon polymers) or a silicone glaze to allow for easy removal of the food product after baking and to prevent corrosion. However, after many uses of a pan having a non-stick coating, the coating may wear down and require re-coating, it may flake off and be ingested by the consumer, or it may be scratched thereby reducing the effectiveness of the coating. In addition, pans having non-stick coatings generally may not be wiped down or scraped after use for the reasons previously discussed.

In contrast, however, pans made of stainless steel may be wiped or scraped after use with no deterioration of the quality of the pan surface. Moreover, stainless steel provides a microstructure that is free of cracks and crevices found in certain other metal materials 18 used to manufacture baking pans currently on the market. For example, baking pans made from metal materials 18 that are slightly porous or have micro-sized cracks and crevices allow food to build-up in those surface defects. In other words, defects in the surface of a baking pan including, but not limited to, pores, cracks, crevices and the like can form points where typical food products used in preparing a final food product may collect and cause build-up of a food product so as to create a potential microbiological hazard. As a result, baking pans having defects in the surfaces of the baking pan typically do not provide a completely hygienic baking pan surface. Consequently, such baking pans may not provide a completely hygienic final food product free of possible microbiological hazards. As used herein, to “not define any points of accumulation” means a surface, device, or apparatus does not provide an area or location where sufficient food debris can collect to create a potential microbiological hazard through regular use.

On the other hand, baking pans made from stainless steel are more hygienic because they lack the cracks and crevices found in baking pans made from certain other metal materials 18 and can, therefore, provide a hygienic food product. Generally, baking pans made from stainless steel are also non-porous, corrosive resistant, durable, maintenance free, non-toxic and cleanable. Moreover, baking pans made from stainless steel also provide a desired microstructure having good wear resistance that allow the baking pan to be wiped or scraped after use of the baking pan.

Similarly, in an embodiment, the panel 12 may define exposed surfaces. The exposed surfaces may be fully accessible to a user and so constructed and arranged as to not define any points of accumulation as discussed herein above. In this embodiment, the full exposure of the exposed surfaces of the panel 12 allows a user to physically remove any build-up of a food product that might occur during use of the hygienic baking pan 10. In this way, the structure of the hygienic baking pan 10 further contributes to the preparation of an hygienic food product.

In an embodiment, the panel 12 may comprise a plurality of concave molds 20, as is shown in FIGS. 1 and 2. In an embodiment, the concave molds may have a substantially smooth surface so as to allow the baking pan to be easily cleaned after use and to prevent food product build-up as discussed herein above.

The concave molds 20 may be formed by shaping a metal material 18 of a predetermined size. In an embodiment, and as shown in FIGS. 1 and 2, the concave molds 20 may have a substantially semi-cylindrical shape. Although the concave molds 20 are illustrated as having such a shape, one of ordinary skill in the art will recognize that the concave molds 20 may have any other geometric shape. For example, the concave molds 20 may be substantially oval, circular, rectangular, triangular or other various geometric shapes.

In an embodiment, the concave molds 20 may have dimensions from about 80 millimeters to about 96 millimeters by about 18 millimeters to about 22 millimeters by about 10 millimeters to about 14 millimeters. In an embodiment, however, the concave molds 20 have, for example, dimensions of 85 millimeters by 20 millimeters by 12 millimeters. The skilled artisan will appreciate that the dimensions of the concave molds 20 may be larger or smaller depending on the desired size and shape of the food product.

Because of certain complexities in forming, for example, stainless steel by methods such as stamping or hydroforming, and because of stresses in the metal material caused by such forming, it is generally difficult to provide, for example, stainless steel baking pans having concave molds 20 with depths greater than 10 millimeters and spaced less than about two inches apart. An advantage of the present disclosure, however, is the ability to provide concave molds 20 that are either stamped or hydroformed in a stainless steel panel 12 where the concave molds 20 may have depths from about 10 millimeters to at least 12 millimeters, or even greater. Further, the concave molds 20 may be spaced from about one inch to about two inches apart. In an embodiment, the concave molds 20 may be spaced, for example, one inch apart, as is shown in FIG. 1.

Further, in an embodiment, the concave molds 20 may have a depth of at least 12 millimeters. Providing a hygienic baking pan 10 having such concave molds not only allows for a greater depth and wider range of sizes of the food product, but also allows for a greater throughput of product in each batch prepared with the hygienic baking pan 10, thereby increasing production yields.

The hygienic baking pan 10 may have any number of concave molds 20 formed in the panel 12. The concave molds 20 may also be arranged in the panel 12 in any pattern desired. In FIG. 1, for example, the hygienic baking pan 10 is shown to have 11 columns and 3 rows of concave molds 20, where the rows and columns are arranged in a substantially rectangular shape. In an embodiment, however, the hygienic baking pan 10 may have from about 8 to about 14 columns and from about 4 to about 8 rows of concave molds. In an embodiment, the hygienic baking pan 10 has 11 columns and 6 rows of concave molds 20, where the rows and columns are arranged in a substantially rectangular shape. The skilled artisan will recognize, however, that the hygienic baking pan 10 may contain any number of concave molds 20 and that the concave molds 20 may be arranged in any pattern according to desirability or manufacturing specifications.

In an embodiment, and as discussed previously, the concave molds 20 may be formed by stamping the metal material 18 using an industrial metal stamping machine. Stamping may be used to form the concave molds 20 because stamping dies are considerably less expensive than mechanical tooling used in other processes such as, for example, molding, forging and casting dies, and expendable cutting tools. Moreover, quality, accuracy, function, wear life and appearance can all be dramatically improved by stamping. However, after forming the concave molds 20 into the panel 12 by stamping, the panel 12 may retain a shape memory imparted to the panel by peripheral metal stress from stamping pressure, as is shown generally in FIG. 2. This shape memory may appear as a slight “bow” or curvature in the structure of the panel 12 thereby preventing the panel 12 from laying flat on a horizontal surface, as is shown generally in FIG. 3.

To relieve any residual internal stresses in the hygienic baking pan 10 caused by forming the metal material 18, the panel 12 may be annealed to remove the shape memory. During the annealing process, the microstructure of the metal material 18 is altered, causing changes in its properties such as strength and hardness. Specifically, annealing is a process that produces equilibrium conditions by heating and maintaining at a suitable temperature, and then cooling very slowly. Annealing is often used to induce softness, relieve internal stresses, refine the structure and improve cold working properties.

For example, the panel 12 may be annealed to relieve internal stresses and allow the panel 12 to lay flat on a horizontal surface, as is shown in FIG. 4. A panel 12 having retained shape memory may be annealed at a temperature of from about 1800° F. to about 2300° F. The panel 12 having retained shape memory may also be annealed at a temperature of about 2050° F. The panel 12 may be held at the annealing temperature for about 6 to about 8 minutes before being cooled to about ambient temperature. The cooling process may take from about 25 minutes to about 35 minutes. Specifically, the cooling process may take about 30 minutes. The skilled artisan will recognize, however, that the parameters of the annealing process may be altered to provide desired changes to the microstructure of the metal material 18.

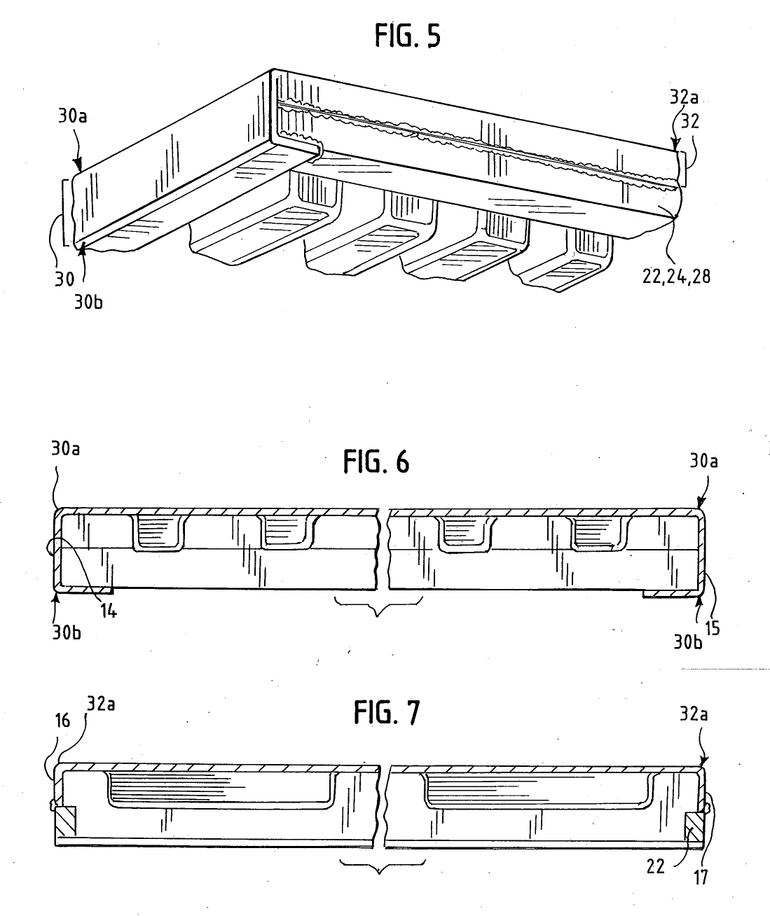

After annealing, and to provide the hygienic baking pan 10 with increased rigidity, the sides 14, 15 and edges 16, 17 of the panel 12 may be folded with a bending brake to form a single fold 32 or a double fold 30, as is shown by FIG. 5. Where there is enough excess metal material 18 on the sides 14, 15 and edges 16, 17 of the panel 12, the panel 12 may be provided with a double fold 30. A double fold 30 is formed by providing two folds to the panel 12. For example, and as shown in FIG. 6, the sides 14, 15 of the panel 12 may be folded in a downward direction to create a first fold 30a that changes the orientation of a side 14, 15 of the panel 12 from a substantially horizontal direction to a substantially vertical direction. After forming the first fold, a second fold 30b may be formed by further folding a side 14, 15 of the panel 12 to change the orientation of the side 14, 15 from a substantially vertical direction to a substantially horizontal direction and extending inward from a side 14, of the panel 12.

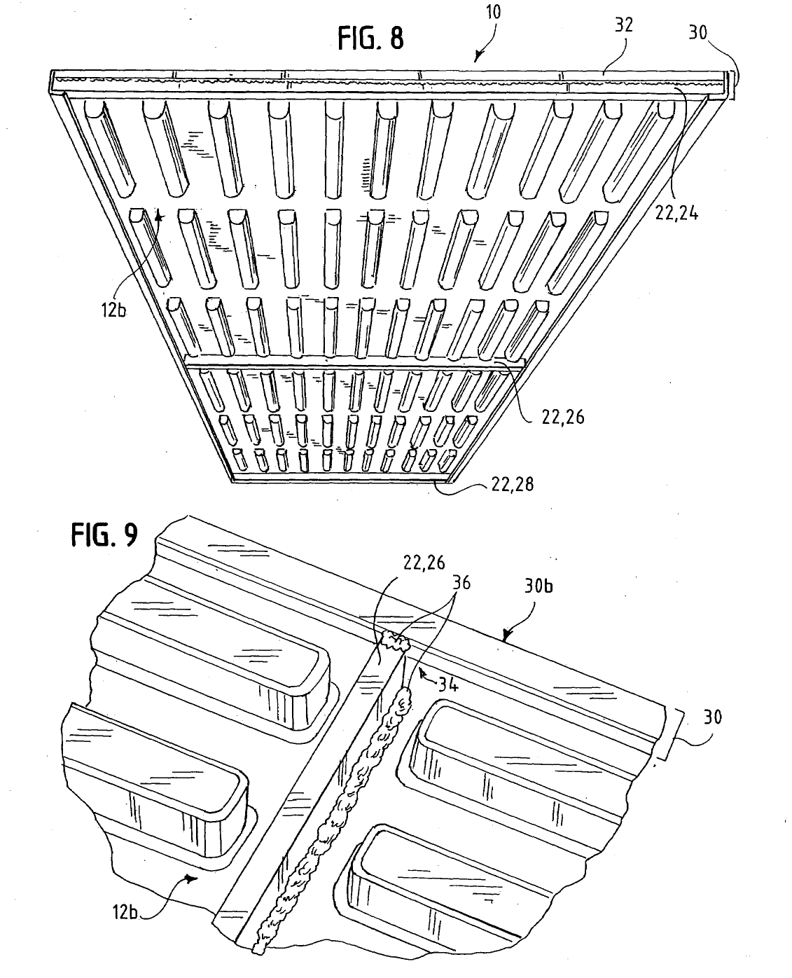

While providing a double fold 30 on both sides 14, 15 and both edges 16, 17 of the hygienic baking pan 10 may be beneficial for purposes of added rigidity, including a double fold 30 on both sides 14, 15 and both edges 16, 17 may be difficult if there is not enough excess metal material 18 to fold on the sides 14, 15 or edges 16, 17 of the panel 12 as can been seen, for example, at the edges 16, 17 of FIG. 2. This problem may occur when manufacturing processes limit the amount of material that may be used in such a mechanical process, or simply when an insufficient amount of material is provided.

Where there is not enough metal material 18 to fold into a double fold 30, the metal material 18 may be folded with a single fold 32, as is shown on the edges 16, 17 of the panel 12 in FIGS. 5 and 7. A single fold 32 is formed in the same way as the first fold 30a of the double fold 30 discussed herein above. For example, and as shown in FIG. 7, the edges 16, 17 of the panel 12 may be folded in a downward direction to form a first fold 32a, where the fold 32a changes the orientation of the edges 16, 17 of the panel 12 from a substantially horizontal direction to a substantially vertical direction to create the single fold 32. Although, for example, FIGS. 5, 6 and 7 show the sides 14, 15 as having a double fold 30, and edges 16, 17 as having a single fold 32, the sides 14, 15 and edges 16, 17 may be provided with double folds 30, single folds 32 or any combination thereof as desired or according to manufacturing standards.

In addition to the double and single folds, 30 and 32, respectively, a frame 22 may be provided as a source of additional support and to provide a desired rigidity to the hygienic baking pan 10. In an embodiment, the frame 22 comprises three support bars 24, 26, 28 that can be seen from a view of the bottom surface 12b of the panel 12 and as shown in FIG. 8. While FIG. 8 is shown to have three support bars 24, 26, 28, the hygienic baking pan 10 may have any number of support bars 24, 26, 28 secured thereto to provide the hygienic baking pan 10 with a desired amount of rigidity. For example, there may be only one or two support bars secured to the hygienic baking pan 10. Similarly, there may be four or five support bars secured to the hygienic baking pan 10.

The support bars 24, 26, 28 may be made from the same metal material 18 as the panel 12 and as discussed herein above. In an embodiment, however, the support bars 24, 26, 28 are made from stainless steel. Moreover, the support bars may have a substantially rectangular shape, T-shape, I-shape, or any other shape desired so long as the support bars deliver the desired rigidity to the hygienic baking pan 10.

In an embodiment, the frame 22 may define exposed surfaces. The exposed surfaces may be fully accessible to a user and so constructed and arranged as to not define any points of accumulation as discussed herein above. In this embodiment, the full exposure of the exposed surfaces of the frame 22, except for junctions where the frame 22 is joined to the panel 12, allows a user to physically remove any build-up of a food product that might occur during use of the hygienic baking pan 10.

The frame 22 may be connected to the single fold 32 of the panel 12 and the portion of the double fold 30 that extends horizontally from the second fold 30b, as shown by FIG. 8. Similarly, the frame 22 may be connected to the bottom surface 12b of the panel 12 and the portion of the double fold 30 that extends horizontally from the second fold 30b, as shown in FIG. 9. While the support bars 24, 26, 28 are shown in FIG. 8 as being joined to the single fold 32 and to the bottom surface 12b of the panel 12 at the illustrated positions, the support bars 24, 26, 28 may be joined to any portion of the hygienic baking pan 10 so long as they provide a desired amount of rigidity. For example, there may be only two support bars secured to the hygienic baking pan 10, wherein the support bars are located at opposite edges 16, 17 of the panel 12. Similarly, for example, the support bars 24, 26, 28 may have different dimensions depending on where they are attached to the panel 12.

In FIG. 5, for example, a support bar 24, 28 may have a smaller width (i.e., the distance that a support bar 24, 28 extends from the single fold 32 to the portion of the double fold 30 that extends horizontally from the second fold 30b) than a support bar 26 that is joined to the bottom surface 12b of the panel 12 and extends downward to the portion of the double fold 30 that extends horizontally from the second fold 30b, as is shown in FIG. 9.

In an embodiment, and as shown in FIG. 9, a support bar 26 joined to the bottom surface 12b of the panel 12 may not extend all the way to the portion of the double fold 30 extending vertically from the first fold 32a to the second fold 32b. In this embodiment, there is a gap 34 formed between the end of a support bar 26 and the portion of the double fold 30 extending vertically from the first fold 32a to the second fold 32b. Including a gap 34 in this location allows for proper cleaning of the hygienic baking pan 10 and ensures that a point of accumulation, as discussed herein above, does not develop in this location.

In an embodiment, the gap 34 formed between the end of the support bar 26 and a vertical portion of the double fold 30 may extend for a majority of a junction between the panel 12 and the double fold 30 of the frame 22. The support bar 26 is joined to the double fold 30 where the support bar 26 and the portion of the double fold 30 that extends horizontally from the second fold 30b meet in a horizontal plane parallel to the top surface 12a of the panel 12, as is shown in FIG. 9. Similarly, the support bars 24 and 28 of a frame 22 may be joined to the single fold 32 and to the portion of the double fold 30 that extends horizontally from the second fold 30b, as is also shown in FIG. 5.

The support bars 24, 26, 28 may be joined to portions of the panel 12 by any joining means known in the art including, but not limited to, welding, soldering, and brazing. In an embodiment brazing, or braze welding, is used to join the support bars 24, 26, 28 to portions of the panel 12. Braze welding generally takes place at the melting temperature of the filler (e.g., 1600° F. to 1800° F. or 870° C. to 980° C. for bronze alloys) which is often considerably lower than the melting point of the base material (e.g., 2900° F. or 1600° C. for mild steel).

In an embodiment, a support bar 26 may be joined to the bottom surface 12b of the panel 12 by a hardened brazing paste 36, as is shown in FIG. 9. The brazing paste may be any non-ferrous metal or metal alloy including, but not limited to, a bronze brazing paste or a brass brazing paste. To securely join the support bars 24, 26, 28 to portions of the panel 12, the brazing paste 36 may be applied to the locations where the support bars 24, 26, 28 meet portions of the panel 12. The brazing paste 36 and panel 12 may then be heated in an oven where it becomes flowable and flows into the crease between the support bars 24, 26, 28 and the panel 12. Upon cooling, the hardened brazing paste 36 securely joins the support bars 24, 26, 28 to the panel 12.

Another aspect of the present disclosure is to provide methods for manufacturing an apparatus for preparing a plurality of individual food products. For example, in an embodiment, a method for manufacturing an apparatus for preparing food products is provided. The method comprises manufacturing a single continuous sheet of metal material to form a tray having a top surface and two sides, forming the metal material sheet to form a plurality of concave molds therein, and joining a frame to the metal material sheet, wherein a gap is formed between the frame and the metal material sheet. In an embodiment, the frame is joined to the metal material sheet using a brazing paste.

In another embodiment, the method for manufacturing an apparatus for preparing food products further comprises annealing the metal material sheet. As discussed previously, the added step of annealing provides relief to internal stresses of a stamped metal material sheet thereby allowing the metal material sheet to lay flat on a horizontal surface. In an embodiment, the metal material may be formed by stamping.

The method for manufacturing an apparatus for preparing food products may further comprise folding the metal material sheet, as described hereinabove, to provide a desired degree of rigidity to the apparatus. For example, in an embodiment, the metal material sheet sides may be provided with a double fold. Similarly, in an embodiment, two metal material sheet edges may be provided with a single fold.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The disclosure is claimed as follows:

1. An apparatus for preparing food products comprising:
a panel having a continuously formed structure comprising at least two sides; and
a frame joined to the panel and defining a gap therebetween.

2. The apparatus of claim 1, wherein the frame comprises at least one support bar.

3. The apparatus of claim 1, wherein each side comprises a double fold, the double fold comprising a first fold that orients the side of the panel from a substantially horizontal direction to a substantially vertical direction, and a second fold that orients the panel from a substantially vertical direction to a substantially horizontal direction extending inward from the side.

4. The apparatus of claim 3, wherein the gap is further defined by a support bar joined to a bottom surface of the panel and the double fold.

5. The apparatus of claim 1, wherein the panel further comprises two edges, wherein each edge comprises a single fold, the single fold comprising a first fold that orients the edge of the panel from a substantially horizontal direction to a substantially vertical direction extending downward from a top surface of the panel.

6. The apparatus of claim 5, wherein the frame comprises three support bars, one support bar being joined to each of the single folds and one support bar being joined to a bottom surface of the panel.

7. The apparatus of claim 1, wherein the gap extends for a majority of a junction between the frame and the panel.

8. The apparatus of claim 1, wherein the panel is made from a material having non-stick properties relative to the food product being prepared.

9. The apparatus of claim 8, wherein the material is stainless steel.

10. An apparatus for preparing food products comprising:
a panel having a continuously formed structure comprising at least two sides and defining exposed surfaces, the exposed surfaces being fully accessible and so constructed and arranged as to not define any points of accumulation.

11. The apparatus of claim 10, comprising a plurality of concave molds formed in the panel.

12. The apparatus of claim 10, comprising a frame joined to the panel defining a gap therebetween and exposed surfaces, the exposed surfaces being fully accessible except at junctions where the frame is joined to the panel and being so constructed and arranged as to not define any points of accumulation.

13. An apparatus for preparing food products comprising:
a stainless steel panel having a continuously formed structure comprising at least two sides.

14. The apparatus of claim 13, comprising a plurality of concave molds formed in the panel.

15. The apparatus of claim 13, comprising a frame joined to the panel defining a gap therebetween, the frame comprising at least one support bar.

16. An apparatus for preparing food products comprising:
a panel comprising a top surface, a bottom surface, and a plurality of concave molds, the concave molds extending downward at least 12 millimeters from the top surface of the panel; and
a frame joined to the panel.

17. The apparatus of claim 16, wherein the concave molds have a substantially semi-cylindrical shape.

18. The apparatus of claim 16, wherein the concave molds have a substantially smooth surface.

19. The apparatus of claim 16, wherein the concave molds have dimensions of from about 80 millimeters to about 96 millimeters by about 18 millimeters to about 22 millimeters by about 10 millimeters to about 14 millimeters.

20. The apparatus of claim 16, wherein the panel is made from stainless steel.

21. The apparatus of claim 16, wherein the frame comprises at least one support bar.

22. The apparatus of claim 16, wherein the concave molds are spaced from about one inch to about two inches apart.

23. The apparatus of claim 16, comprising from about 8 to about 14 columns and from about 4 to about 8 rows of concave molds.

24. A method for manufacturing an apparatus for preparing food products, the method comprising:
manufacturing a single continuous sheet of metal material to form a tray having a top surface and two sides;
forming the metal material sheet to form a plurality of concave molds therein; and
joining a frame to the metal material sheet, wherein a gap is formed between the frame and the metal material sheet.

25. The method of claim 24, wherein the metal material is stainless steel.

26. The method of claim 24, wherein the metal material sheet is formed by stamping.

27. The method of claim 24, further comprising annealing the metal material sheet.

28. The method of claim 24, further comprising folding the sides of the metal material sheet sides with a double fold.

29. The method of claim 24, further comprising folding two edges of the metal material sheet with a single fold.

30. The method of claim 24, further comprising using a brazing paste to join the frame to the metal material sheet.
